(19) United States
(12) Patent Application Publication
(10) Pub. No.: US 2005/0236089 A1
(43) Pub. Date: Oct. 27, 2005

(54) Capsules for bottles and other containers

(76) Inventor: Oscar Lavaque, Buenos Aires (AR)

Correspondence Address: John Dodds, 1707 N St. NW, Washington, DC, 20036, US

(21) Appl. No.: 10/832,626

(22) Filed: Apr. 27, 2004

(51) Int. Cl. B29C 63/40; B32B 31/00

(52) U.S. Cl. 156/86; 215/246; 264/230; 156/249

(57) ABSTRACT

A method to form a bottle closure from flat thermo shrinkable plastic components is disclosed. The capsules formed according to this method can be manufactured and inserted while the bottles are transported on belts with speed control.

The applicant claims priority of the Argentinean patent application filed on Jan. 3th 2004.

### BACKGROUND OF THE INVENTION

1. Field of the Invention

This invention relates to closures for bottles and containers, and in particular to closures for wine bottles.

2. Description of the Related Art

The current methods to seal bottles and containers include use of lead capsules or laminated tin. Lead capsules have the disadvantage that they may leave traces of poisonous chemicals on the glass surface. In addition to this, lead is heavy and expensive material.

A more recent application of non toxic metal foils has however, the same characteristics of the material being heavy and expensive. U.S. Pat. No. 5,172,460 discloses use of lead-free laminate of metal foil-plastic as a material to form conical capsules by drawing the laminate from a flat blank to a seamless capsule.

Metallic materials have been also replaced by use of plastic materials. The plastic material is provided as a tubular role. The capsules are formed and cut from this tubular plastic. The problem with this kind of sealing process is that insertion of the plastic cone on the top of the already corked bottle needs a second machine with the objective to introduce the plastic cone on the bottle and adjust it into its position. U.S. Pat. No. 5,118,460 for example discloses a method to produce shrinkable thermoplastic bottle capsules by blow molding of tubular plastic material.

Another method currently known is disclosed in U.S. Pat. Nos. 5,261,547 and 5,447,246: use of injection of liquid thermoplastic material onto the top of the cork so that when the material hardens it forms a seal on the top of the cork. A disadvantage of this method is that the sealing formed does not give the aesthetic finish of traditional wine bottle capsule.

U.S. Pat. No. 2,790,286 discloses a secondary closure made of heat shrinkable band that shrinks onto the neck of the bottle. The disadvantage of this method is the requirement of a swelling agent or chemical such as xylene to adhere the plastic around the neck. Furthermore, this method does not provide a capsule that would have the aesthetic look of conventional wine bottle capsule but rather fits for closure of drug bottles and the like.

The disadvantages of the currently known methods are that the material when being metal foil is heavy and expensive to transport. Each of the methods having a step of forming a conical capsule from one piece -be it metal or plastic, needs an additional machine to form the capsule and insert it on the top of the corked bottle. Moreover, the thickness of all the conventional capsules is always more than 75 microns, while according to the present invention the capsules can be clearly thinner and therefore easier to handle and transport.

Furthermore, based on longstanding tradition, the capsule of a wine bottle is considered an important part of the bottle, especially in providing a decorative closure. Therefore, at least for premium wines, the capsule and label are considered important decorative elements and several of the above described methods are not suitable to provide such decorative and aesthetic finish.

The present invention solves the above described problems by providing a simple and economic method to form an aesthetic capsule on the top of a corked bottle.

### BRIEF SUMMARY OF THE INVENTION

Definition of Terms

In this disclosure the term “corked” is used to mean closing of a bottle or container with any kind of cap; i.e. the term corked covers also screwed closures or corks made of any material, including but not limited to natural cork, plastic and metal.

In this disclosure the term “bottle” is used to include any kind of beverage containers; i.e. the term bottle covers various jars and bottles, including but not limited to containers made of glass, plastic, or metal.

The present invention is directed to a method to seal a corked bottle by use of two flat thermo shrinkable plastic components forming a capsule that permits decorative finishing with top and side labels.

One object of the present invention is to provide a simplified procedure to protect the mouth of a corked bottle with a capsule that can be so finished that it resembles a traditional wine bottle capsule with colors, prints and labels.

Another object of the present disclosure is to provide a new type of bottle sealing capsule that is manufactured in two parts.

A still further objective of the present invention is to provide a bottle capsule the material of which is delivered in rolls.

A still another objective of the present invention is to provide a method to insert a capsule on corked bottles having lower costs and manufacturing time and simultaneously providing a reliable bottle sealing that does not permit penetration of air nor contamination to the bottle mouth.

A still further objective of the present invention is to provide a method to insert a new type of bottle capsule on corked bottles the method being applicable to any system that uses transporting belts with speed control.

### BRIEF DESCRIPTION OF THE SEVERAL VIEWS OF THE DRAWINGS

FIG. 1. Illustrates a strip of thermo shrinkable plastic having the top discs printed on it.

FIG. 2. Illustrates a strip of thermo shrinkable plastic with printed decorative figures on it. The strip is to be wrapped vertically on the bottle neck.

FIG. 3. Illustrates a strip of thermo shrinkable plastic with printed decorative figures and a printed seal on it. The strip is to be wrapped vertically on the bottle neck so that the seal print shall form an impression of a real seal.

FIG. 4. is a side view illustrating the method to capsule the bottle. A flat cover disc is separated from the strip and placed on the top of the bottle cork. The vertical strip is wrapped around the bottle neck by turning the bottle. The capsule is formed by imposing the top of the bottle to heat whereby the overlapping strip parts form final contact.

FIGS. 5A and B. Illustrate alternative embodiment where the first and the second component are provided from one sheet. In FIG. 5A the first and the second components are placed in two lines. In FIG. 5B the components are placed in a sequential order.

### DETAILED DESCRIPTION OF THE INVENTION

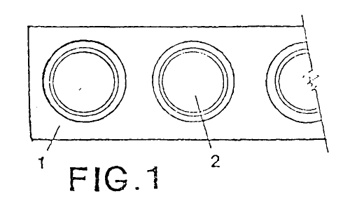

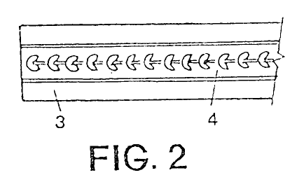

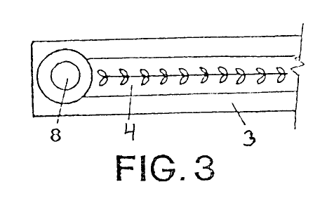

The present disclosure provides a method to manufacture a capsule on a corked bottle from flat components made of thermo shrinkable plastic. Referring to FIGS. 1 to 5 the first component is a circular center piece 2 having a radius such that it can be positioned on the top of the cork. A plurality of the first components may be provided as a roll of thermo shrinkable plastic strip 1 where the first component discs are printed so that they can be detached from the roll and then inserted on the top of the cork 15. The first component forms the top of the capsule.

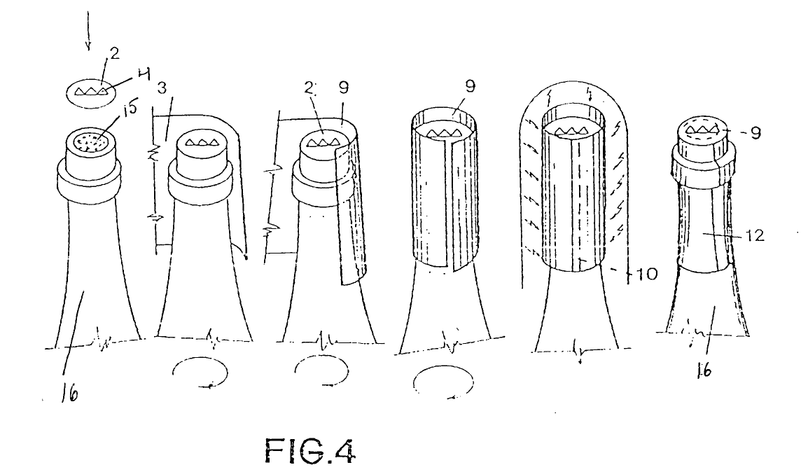

The second component is flat thermoplastic strip 3 that is wrapped around the bottle neck 16. The second component forms the side surface of the capsule. The strip can be of various widths. In a preferred embodiment the strip is wide and it may be wrapped around the bottle neck so that it forms only one layer and the end of the strip overlaps only narrowly the beginning of the strip. The overlapping area is shown as element 10 in FIG. 4. In another embodiment the strip is narrower and shall in that case be wrapped over the neck several times so that it forms a spiral on the bottle neck. In both of these embodiments the end of the strip may be attached to the overlapping part of the strip by using an adhesive.

In preferred embodiment the second component 3 is wrapped around the neck of the bottle 16 so that part of the film 9 exceeds the top of the bottle. This part of the film 9 is to be used to form the contraction between the two components.

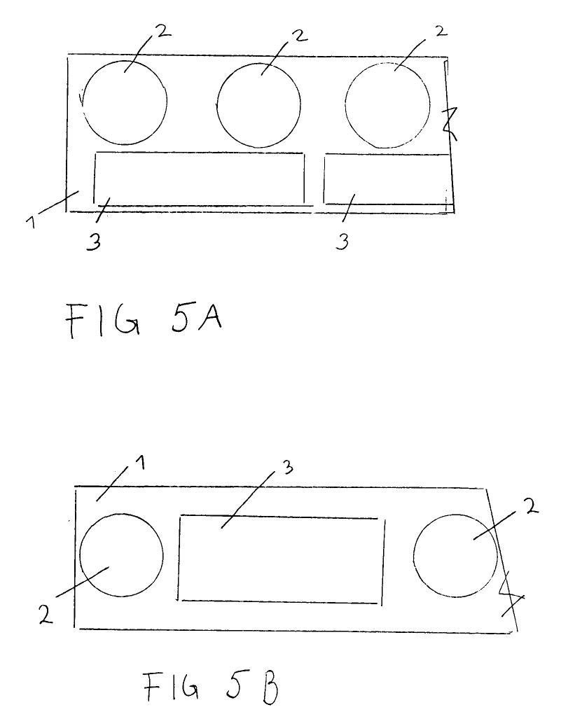

According to another embodiment of this invention the first and the second components 2 and 3, respectively are provided on one sheet. According to this embodiment the first and the second components may be placed on the one sheet in two lines, so that one side of the sheet contains the first components and the other side of the sheet contains the second components. This embodiment is illustrated in FIG. 5A. The first and the second components may also be placed on the sheet in a sequential order so that every second component is the first component and every second is the second one as schematically illustrated in FIG. 5B. Other placements of the components may also be applied.

The process is completed by applying heat to obtain the final thermo contraction of the two components.

According to still another embodiment the capsule is formed from one flat rectangular piece of thermo shrinkable material. According to this embodiment the rectangular piece is wrapped around the bottle neck 15 so that about ⅓ of the width of the rectangle remains above the mouth of the bottle and about ⅔ of the width covers the neck of the bottle. The capsule is formed by applying heat whereby the part that is above the mouth of the bottle forms the top part of the capsule.

The advantage of the present invention is that both of the two components can be delivered in flat roles of 95 micron of thickness. Therefore, transportation and delivery of the components does not need any special attention or care, like transportation of the conventional cones do need. Also the space taken by the components is extremely small because of the thinness of the components.

The capsule according to the present invention can be inserted on the corked bottle when the bottle advances from the production line. The central disc 2 is separated from the plastic strip 1 and is placed over the mouth of the bottle to cover the mouth already closed with a cork. Simultaneously, the side surface of the capsule is provided by wrapping the second component 3 on the neck of the bottle 16. The wrapping process may be completed by turning the bottle around so that the film is wrapped around the bottle or the thermo shrinkable film is relieved from the roll and wrapped around the bottle neck. The strip may be attached on the overlapping area 10 by applying an adhesive to the end surface of the strip. The side surface shall be so wrapped that the part of the strip exceeds the top of the bottle 9.

An advantage of the present invention is that the method of forming capsules according to this disclosure can be applied in any system using a transportation belt with a speed control. The method provided in this disclosure can be applied to capsule about 200-300 bottles per minute.

The process is concluded by applying heat on the capsule element thereby providing the contraction of the thermo shrinkable film. The heat shall compress the portion of the strip 9 that exceeds the bottle mouth to the central disc 2, thereby forming a conical capsule 12.

The thermo shrinkable material according to the present invention may be but is not limited to thermo shrinkable PVC film. The thermo shrinkable material according to the present disclosure may be any polymeric plastic material. The thickness of such film is around 40 to 50 microns, which is clearly less than the conventional materials that are always at least 75 microns at their thickness.

The present invention can be also realized with Crystal PVC or other polymeric plastic, which enables printing of symbols 4, seals 8 or brands on the film. By using this material the capsule can also be obtained in different colors.

While the present invention has been described in detail by way of illustration an example for purposes of clarity of understanding, it is clear to one skilled in the art that several changes and modifications may be made without departing the spirit and scope of the invention as defined by the claims.

1. A method to form a capsule for bottles and containers, said method comprising the steps of:
a) providing a plurality of a first and a second component of the capsules in a form of a first roll of thermo shrinkable plastic film wherein the first components are detachably printed and a second roll of thermo shrinkable plastic film wherein the second components are detachably printed;
b) detaching a first component from the first roll of plastic film, said first component being a flat disc and placing it on a top of the bottle;
c) wrapping the second component around the neck of the bottle at least once by unrolling it from the second roll and further unrolling it so that part of the film exceeds the top of the bottle; and
d) applying heat on the components, whereby the part of the second component that exceeds the top of the bottle compresses the first component and the first and the second component form a capsule.

2. The method according to claim 1, wherein wrapping of the second component is secured by adding adhesive on a narrow area where the second component is overlapping.

3. The method according to claim 1, wherein the second component is narrow and is wrapped spirally on the neck of the bottle.

4. The method according to claim 2, wherein the second component is narrow and is wrapped spirally on the neck of the bottle.

5. The method according to claim 1, wherein the first component comprises a printed seal.

6. The method according to claim 1, wherein the second component comprises a printed seal.

7. The method according to claim 1, wherein the plastic film is colored.

8. The method according to claim 1, wherein the plastic film is PVC film approximately 40 to 50 microns thick.

9. A method to form a capsule for bottles and containers, said method comprising the steps of:
a) providing a plurality of a first and a second component of the capsules in a form of a roll of thermo shrinkable plastic film wherein the first and the second components are detachably printed;
b) detaching a first component from the roll of plastic film, said first component being a flat disc and placing it on a top of the bottle;
c) wrapping the second component around the neck of the bottle at least once by unrolling it from the roll and further unrolling it so that part of the film exceeds the top of the bottle; and
d) applying heat on the components, whereby the part of the second component that exceeds the top of the bottle compresses the first component and the first and the second component form a capsule.

10. The method according to claim 9, wherein wrapping of the second component is secured by adding adhesive on a narrow area where the second component is overlapping.

11. The method according to claim 9, wherein the second component is narrow and is wrapped spirally on the neck of the bottle.

12. The method according to claim 10, wherein the second component is narrow and is wrapped spirally on the neck of the bottle.

13. The method according to claim 9, wherein the first component comprises a printed seal.

14. The method according to claim 9, wherein the second component comprises a printed seal.

15. The method according to claim 9, wherein the plastic film is colored.

16. The method according to claim 9, wherein the plastic film is PVC film approximately 40 to 50 microns thick.

17. A capsule for bottles and containers, said capsule being formed of two components made of thermo shrinkable plastic film, the first component being a flat disc inserted on top of a bottle and the second component being a strip wrapped around neck of the bottle;
said first and second components being compressed together by subjecting them to heat, whereby the first and the second component form the capsule.

18. The capsule according to claim 17, wherein the second component is secured by adding adhesive on a narrow area where the second component is overlapping.

19. The capsule according to claim 17, wherein the second component is narrow and is wrapped spirally on the neck of the bottle.

20. The capsule according to claim 18, wherein the second component is narrow and is wrapped spirally on the neck of the bottle

21. The capsule according to claim 17, wherein the first component comprises a printed seal.

22. The capsule according to claim 17, wherein the second component comprises a printed seal.

23. The capsule according to claim 17, wherein the plastic film is colored.

24. The capsule according to claim 17, wherein the plastic film is PVC film approximately 40 to 50 microns thick.

25. A method to form a capsule for bottles and containers, said method comprising the steps of:
a) providing a plurality of a rectangular components in a form of a roll of thermo shrinkable plastic film wherein the components are detachably printed;
b) detaching a component from the roll of plastic film;
c) wrapping the component around the neck of the bottle at least once and further unrolling it so that part of the film exceeds the top of the bottle; and
d) applying heat on the component, whereby the part of the component that exceeds the top of the bottle compresses above the top of the bottle thereby forming top of the capsule.
